(19) United States
(12) Patent Application Publication
(10) Pub. No.: US 2025/0370298 A1
(43) Pub. Date: Dec. 4, 2025

(54) OPTICAL ELEMENT, AND METHOD FOR PRODUCING OPTICAL ELEMENT

(71) Applicant: Sharp Display Technology Corporation, Kameyama City (JP)

(72) Inventors: Ryosuke SAIGUSA, Kameyama City (JP); Akira Sakai, Kameyama City (JP); Yuichi Kawahira, Kameyama City (JP); Kiyoshi Minoura, Kameyama City (JP); Hiroaki Asagi, Kameyama City (JP)

(21) Appl. No.: 19/203,423

(22) Filed: May 9, 2025

(30) Foreign Application Priority Data
May 29, 2024 (JP) 2024-087004

(51) Int. Cl. G02F 1/1337

(52) U.S. Cl. CPC G02F 1/1337

(57) ABSTRACT

Provided are an optical element that has a high diffraction efficiency and can reduce or prevent haze, and a method for producing the optical element. The optical element of the present invention includes an alignment film and an optically anisotropic layer provided on the alignment film and containing anisotropic molecules. The alignment film includes first to N-th alignment treatment regions arranged in order from a central portion to an end portion of the alignment film in a plan view. The first to N-th alignment treatment regions respectively include first to N-th protrusions which protrude toward the optically anisotropic layer and respectively extend in first to N-th directions. The first to (N−1)th directions are not parallel to one another. The N-th direction is parallel to the first direction. N is an integer of 3 or greater.

### CROSS-REFERENCE TO RELATED APPLICATIONS

The present application claims priority under 35 U.S.C. § 119 to Japanese Patent Application No. 2024-087004 filed on May 29, 2024, the contents of which are incorporated herein by reference in their entirety.

### BACKGROUND OF THE INVENTION

### Field of the Invention

The present disclosure relates to optical elements and methods for producing an optical element.

### Description of Related Art

There have been suggestions to use an optical system including an optical element such as a Pancharatnam-Berry phase optical element (PBOE) in a head-mounted display or other display devices. A PBOE includes, for example, an optically anisotropic layer formed from a liquid crystal composition containing liquid crystal molecules.

JP 2011-112831 A discloses, as a technique related to optical elements, a grating element including diffraction gratings stacked on at least one resin sheet. At least one diffraction grating among the stacked diffraction gratings is a polarizing diffraction grating made of a uniaxial polymer liquid crystal, and at least one diffraction grating among the stacked diffraction gratings is a non-polarizing diffraction grating made of a photo-curable resin.

### BRIEF SUMMARY OF THE INVENTION

To achieve a PBOE having a high diffraction efficiency, the molecular alignment thereof needs to be brought closer to the ideal state. Here, a PBOE is produced by a method such as mask exposure, for example. In production of a PBOE by mask exposure, an alignment treatment is performed in which the alignment film on a supporting substrate is exposed to light multiple times through masks. A misalignment of the masks during the treatment would disturb the molecular alignment, possibly decreasing the diffraction efficiency. There is also a possibility that the same region of the alignment film is exposed to mutually orthogonal polarized ultraviolet (also referred to as PUV) light rays. This may cause haze (turbidity) and lower the display quality.

JP 2011-112831 A does not disclose an optical element that has a high diffraction efficiency and can reduce or prevent haze.

In response to the above issues, an object of the present invention is to provide an optical element that has a high diffraction efficiency and can reduce or prevent haze, and a method for producing the optical element.

(1) One embodiment of the present invention is directed to an optical element including: an alignment film; and an optically anisotropic layer provided on the alignment film and containing anisotropic molecules, the alignment film including a first alignment treatment region to an N-th alignment treatment region arranged in order from a central portion to an end portion of the alignment film in a plan view, the first alignment treatment region to the N-th alignment treatment region respectively including first protrusions to N-th protrusions which protrude toward the optically anisotropic layer and respectively extend in a first direction to an N-th direction, the first direction to an (N−1)th direction being not parallel to one another, the N-th direction being parallel to the first direction, N being an integer of 3 or greater.

(2) In an embodiment of the present invention, the optical element includes the structure (1), with a direction identical to the first direction taken as a reference direction in a plan view, an angle between the N-th direction and the reference direction is within a range of 180°±3°, and angles between each of the second direction to the (N−1)th direction and the reference direction increase progressively in ascending order within a range of greater than an angle between the first direction and the reference direction and less than the angle between the N-th direction and the reference direction.

(3) In an embodiment of the present invention, the optical element includes the structure (1) or (2), and with a direction identical to the first direction taken as a reference direction in a plan view, an angle between an i-th direction and the reference direction satisfies the following Inequality (A):

$$\{ \frac{( i - 1 ) \times 180 °}{( N - 1 )} \} - 3 ° < Angle between i - th direction and reference direction < \{ \frac{( i - 1 ) \times 180 °}{( N - 1 )} \} + 3 ° \qquad Inequality ( A )$$

where i represents an integer of 2 or greater and N or less.

(4) In an embodiment of the present invention, the optical element includes the structure (1), (2), or (3), and the following Inequality (B1) holds:

$$\frac{( Pitch P )}{( Number of partitions Q )} < 22.5 μm \qquad Inequality ( B1 )$$

where the pitch P is a total length of the first alignment treatment region to the N-th alignment treatment region on a straight line from the central portion to the end portion of the alignment film, and the number of partitions Q equals N−1.

(5) In an embodiment of the present invention, the optical element includes the structure (1), (2), (3), or (4), and the following Inequality (B2) holds:

$$\frac{( Pitch P )}{( Number of partitions Q )} \leq 10 μm \qquad Inequality ( B2 )$$

where the pitch P is a total length of the first alignment treatment region to the N-th alignment treatment region on a straight line from the central portion to the end portion of the alignment film, and the number of partitions Q equals N−1.

(6) In an embodiment of the present invention, the optical element includes the structure (1), (2), (3), (4), or (5), and a height H of the first protrusions to the N-th protrusions is less than a phase difference Δnd of the optically anisotropic layer.

(7) In an embodiment of the present invention, the optical element includes the structure (1), (2), (3), (4), (5), or (6), and a protrusion pitch W satisfies the following Inequality (C):

$$Protrusion pitch W < \frac{( Pitch P )}{( Number of partitions Q )} \qquad Inequality ( C )$$

where the protrusion pitch W is a pitch of the first protrusions to the N-th protrusions, the pitch P is a total length of the first alignment treatment region to the N-th alignment treatment region on a straight line from the central portion to the end portion of the alignment film, and the number of partitions Q equals N−1.

(8) In an embodiment of the present invention, the optical element includes the structure (1), (2), (3), (4), (5), (6), or (7), the anisotropic molecules are molecules having an elongated shape, and in regions of the optically anisotropic layer corresponding to the first alignment treatment region to the N-th alignment treatment region, respectively, the anisotropic molecules are aligned with their long axes lying along the first direction to the N-th direction.

(9) In an embodiment of the present invention, the optical element includes the structure (1), (2), (3), (4), (5), (6), (7), or (8), and N is 4 or greater.

(10) Another embodiment of the present invention is directed to a method for producing an optical element, the method including: transferring including transferring a protruded and recessed structure of a die onto a resin layer to form an alignment film; and forming a liquid crystal layer including placing a polymerizable liquid crystal material on a surface of the alignment film onto which a shape of the die has been transferred, followed by curing the material, the die including a first region to an N-th region arranged in order from a portion corresponding to a central portion of the alignment film to a portion corresponding to an end portion of the alignment film, the first region to the N-th region respectively including first wall-shaped portions to N-th wall-shaped portions respectively extending in a first direction to an N-th direction, the first direction to an (N−1)th direction being not parallel to one another, the N-th direction being parallel to the first direction, N being an integer of 3 or greater.

The present invention can provide an optical element that has a high diffraction efficiency and can reduce or prevent haze, and a method for producing the optical element.

### BRIEF DESCRIPTION OF THE DRAWINGS

FIG. 1 is a schematic plan view of an optical element of Embodiment 1.

FIG. 2 is an enlarged schematic perspective view of an alignment film in the optical element of Embodiment 1.

FIG. 3 is a schematic cross-sectional view illustrating PBOE production by mask exposure.

FIG. 4 is a schematic view illustrating an example method for producing the optical element of Embodiment 1.

FIG. 5 is a schematic plan view showing an example die with protrusions and recesses used in production of the optical element of Embodiment 1.

FIG. 6 is a scanning electron microscope photograph of a cross section taken along line V1-V2 in FIG. 5.

FIG. 7 is a polarizing microscope photograph showing an example optical element of Embodiment 1.

FIG. 8 is a schematic cross-sectional view of the optical element of Embodiment 1 taken along line X1-X2 in FIG. 7.

FIG. 9 is a polarizing microscope photograph showing an example optical element of Embodiment 1.

FIG. 10 is a schematic cross-sectional view of the optical element of Embodiment 1 taken along line Y1-Y2 in FIG. 9.

FIG. 11 is a polarizing microscope photograph showing an example optical element of Embodiment 1.

FIG. 12 is a schematic perspective view showing an example protruded and recessed shape of an alignment film in the optical element of Embodiment 1.

FIG. 13 is a schematic perspective view showing an example protruded and recessed shape of the alignment film in the optical element of Embodiment 1.

FIG. 14 is a scanning electron microscope photograph of a die used in production of an optical element of Comparative Example 2.

FIG. 15 is a polarizing microscope photograph of an optical element of Example 1.

FIG. 16 is a diagram showing the evaluation results of the optical element of Example 1.

FIG. 17 is a diagram showing the evaluation results of an optical element of Example 2.

FIG. 18 is a diagram showing the evaluation results of an optical element of Example 3.

FIG. 19 is a diagram showing the evaluation results of an optical element of Example 4.

FIG. 20 is a diagram showing the molecular alignments used for calculation of the diffraction efficiency of an optical element of Reference Example 1.

FIG. 21 is a schematic view showing a method for measuring diffraction efficiency.

### DETAILED DESCRIPTION OF THE INVENTION

Hereinafter, embodiments of the present invention are described. The present invention is not limited to the contents of the following embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

### Embodiment 1

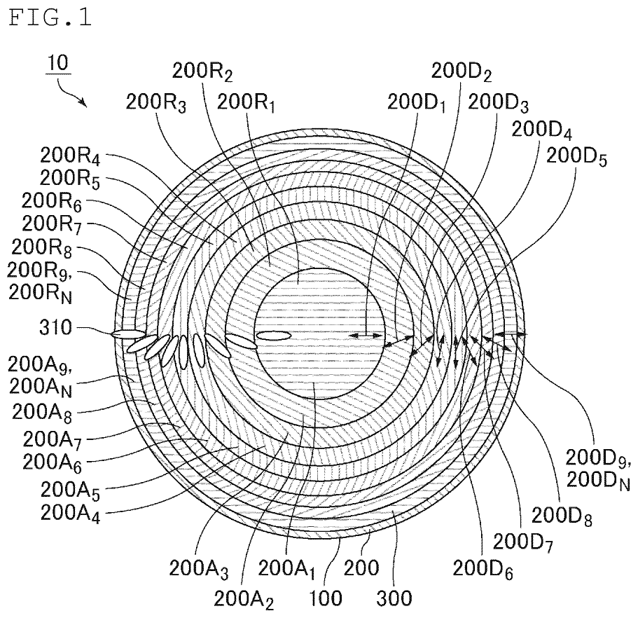

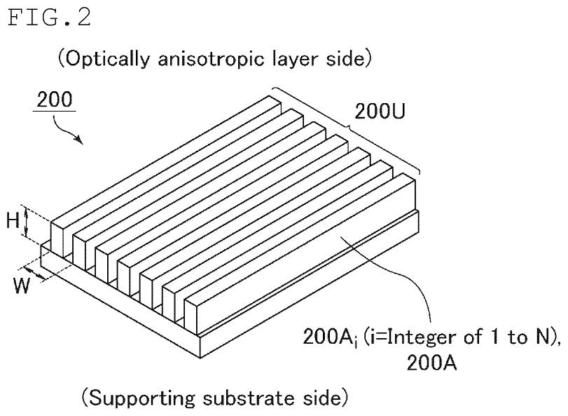

FIG. 1 is a schematic plan view of an optical element of Embodiment 1. FIG. 2 is an enlarged schematic perspective view of an alignment film in the optical element of Embodiment 1. An optical element 10 of the present embodiment shown in FIG. 1 and FIG. 2 includes an alignment film 200 and an optically anisotropic layer 300 provided on the alignment film 200 and containing anisotropic molecules 310. The alignment film 200 includes a first alignment treatment region 200R₁ to an N-th alignment treatment region 200R_{N} arranged in order from the central portion to the end portion of the alignment film 200 in a plan view. The first alignment treatment region 200R₁ to the N-th alignment treatment region 200R_{N} respectively include first protrusions 200A₁ to N-th protrusions 200A_{N} which protrude toward the optically anisotropic layer 300 and respectively extend in a first direction 200D₁ to an N-th direction 200D_{N}. The first direction 200D₁ to an (N−1)th direction 200D_{N-1} are not parallel to one another. The N-th direction 200D_{N} is parallel to the first direction 200D₁. N is an integer of 3 or greater. This structure can achieve an optical element (specifically, a Pancharatnam-Berry phase optical element (PBOE)) that has a high diffraction efficiency and can reduce or prevent haze.

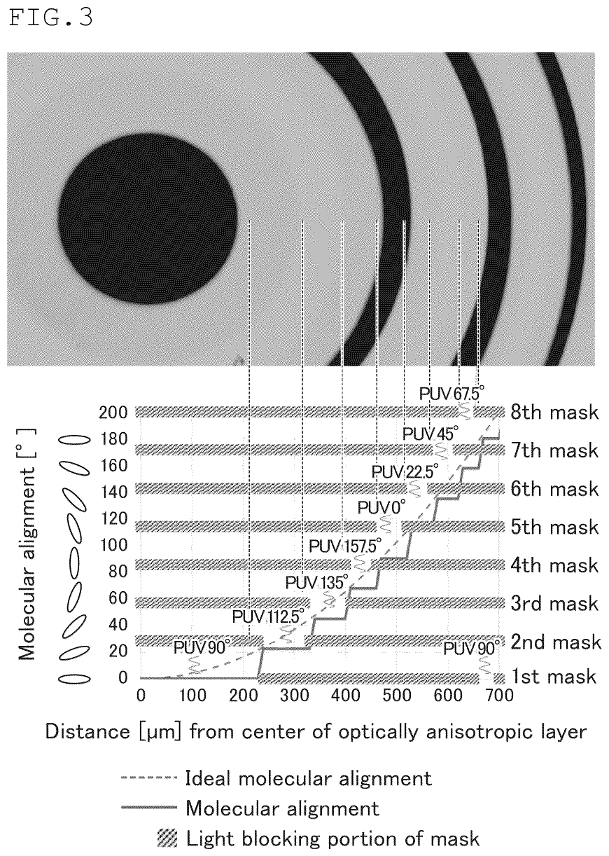

A PBOE is an optical element that functions based on an in-plane periodic molecular alignment pattern. To produce a practical optical element, the molecules thereof need to undergo 180° rotation with a periodicity on the order of micrometers. Also, to produce a PBOE having a high diffraction efficiency, the molecular alignments thereof need to be ideally continuous. Thus, in PBOE production by mask exposure that achieves discrete molecular alignments, as shown in FIG. 3, the number of masks is increased to bring the alignments closer to the ideal one. However, the increase in the number of masks involves misalignment due to a decrease in mask alignment accuracy, deterioration of display quality due to generation of haze, poor productivity due to an increase in the number of steps, and the like issues. FIG. 3 is a schematic cross-sectional view illustrating PBOE production by mask exposure.

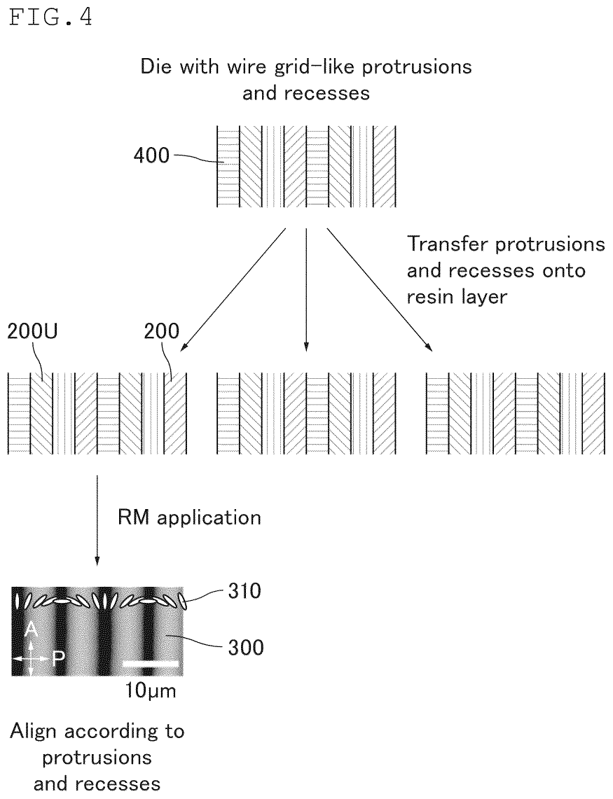

In contrast, the present embodiment can achieve highly reproducible PBOE production without highly accurate mask alignment, owing to the molecular alignment patterning of the anisotropic molecules 310 using the protruded and recessed pattern of the alignment film 200. In the present embodiment, as shown in FIG. 4, the anisotropic molecules 310 (for example, reactive mesogens (also referred to as RMs)) are aligned using a protruded and recessed shape 200U provided by nanoimprinting or the like on the surface of the alignment film 200 on the optically anisotropic layer 300 side, so that the optical element 10, which is a diffractive element, is produced. FIG. 4 is a schematic view illustrating an example method for producing the optical element of Embodiment 1.

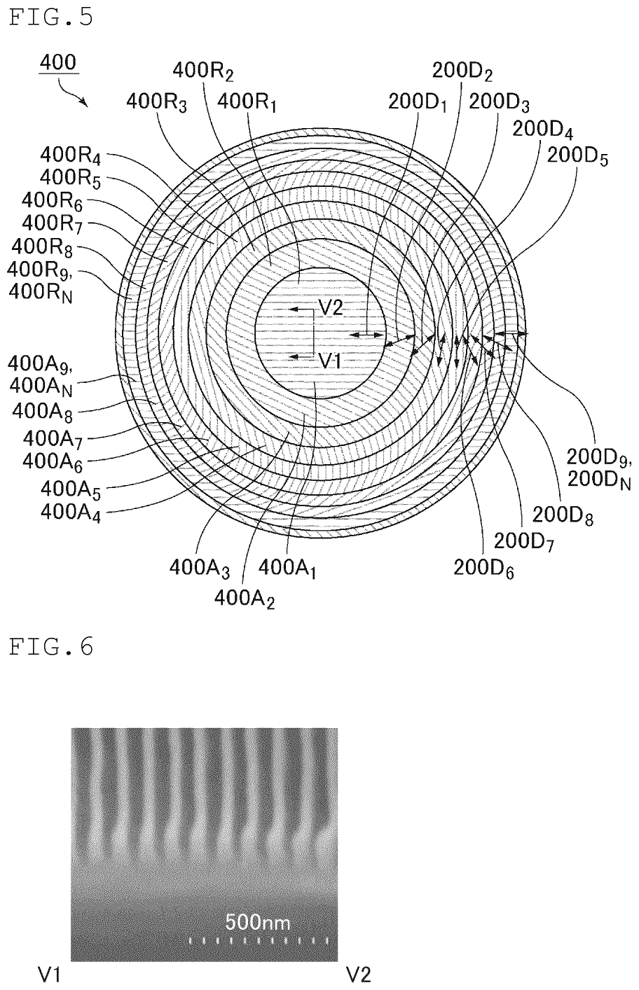

Specifically, a die 400 with wire grid-like protrusions and recesses as shown in FIG. 4 to FIG. 6 is pressed onto a substrate (alignment film 200) to transfer the protruded and recessed shape onto the substrate, and a composition containing RMs is applied to the substrate. This can align the RMs according to the protruded and recessed shape of the substrate. Such a method of the present embodiment avoids the decrease in diffraction efficiency due to a decrease in alignment accuracy, enabling stable production of the optical element 10 having a high diffraction efficiency. Also, the same region of the alignment film is not irradiated with mutually orthogonal polarized ultraviolet rays, so that haze can be reduced. In addition, multiple exposure processes using multiple masks are not required, which can increase the productivity. FIG. 5 is a schematic plan view showing an example die with protrusions and recesses used in production of the optical element of Embodiment 1. FIG. 6 is a scanning electron microscope photograph of a cross section taken along line V1-V2 in FIG. 5.

In this manner, in the present embodiment, a protruded and recessed pattern on the order of wavelengths is formed on a substrate, and RMs are aligned continuously by the interaction between the grooved (recessed) structure and the RMs to produce a PBOE. In this case, a risk factor of molecular misalignment, such as mask exposure, is eliminated, and thus an easily producible, stable-quality PBOE can be produced.

JP 2011-112831 A discloses a technique of producing a diffraction grating by aligning a polymerizable liquid crystal using protrusions and recesses. JP 2011-112831 A, however, does not disclose increasing the diffraction efficiency by continuous alignment of a polymerizable liquid crystal.

The optical element 10 of the present embodiment and the method for producing the optical element 10 are described in detail below.

The optical element 10 of the present embodiment includes, as shown in FIG. 1, a supporting substrate 100, an alignment film 200, and an optically anisotropic layer 300 in order. The optical element 10 of the present embodiment is a Pancharatnam-Berry phase optical element. The Pancharatnam-Berry phase optical element has a function of causing circularly polarized light to converge and diverge.

Examples of the supporting substrate 100 include substrates such as glass substrates and plastic substrates. Examples of the material for the glass substrates include glass such as float glass and soda-lime glass. Examples of the material for the plastic substrates include plastics such as polyethylene terephthalate, polybutylene terephthalate, polyethersulfone, polycarbonate, and alicyclic polyolefin.

The alignment film 200 has a function of regulating the alignment of the anisotropic molecules 310 in the optically anisotropic layer 300. The alignment film 200 contains an alignment film polymer. Examples of the alignment film polymer include polymers with a polyimide structure in their main chain, polymers with a polyamic acid structure in their main chain, polymers with a poly(meth)acrylic acid structure in their main chain, polymers with a polyethylene structure in their main chain, polymers with a polystyrene structure in their main chain, polymers with a polyvinyl structure in their main chain, polymers with a polysiloxane structure in their main chain, and other polymers (resins) common in the field of liquid crystal panels.

The alignment film 200 can be obtained, for example, by applying an alignment film material containing an alignment film polymer to the supporting substrate 100 to form a resin layer, and transferring the protruded and recessed shape of a die onto the resin layer.

The alignment film 200 includes the first alignment treatment region 200R₁ to the N-th alignment treatment region 200R_{N} arranged in order from the central portion to the end portion of the alignment film 200 in a plan view. The first alignment treatment region 200R₁ to the N-th alignment treatment region 200R_{N} respectively include the first protrusions 200A₁ to the N-th protrusions 200A_{N} which protrude toward the optically anisotropic layer 300 and respectively extend in the first direction 200D₁ to the N-th direction 200D_{N}. In other words, an i-th alignment treatment region 200Rᵢ includes i-th protrusions 200Aᵢ which protrude toward the optically anisotropic layer 300 and extend in an i-th direction 200Dᵢ (wherein i is an integer of 1 or greater and N or less). The first direction 200D₁ to the (N−1)th direction 200D_{N-1} are not parallel to one another. The N-th direction 200D_{N} is parallel to the first direction 200D₁. N is an integer of 3 or greater.

N is preferably an integer of 4 or greater, more preferably an integer of 8 or greater, still more preferably an integer of 12 or greater. This structure enables a higher diffraction efficiency and further reduction or prevention of haze. N is, for example, preferably an integer of 90 or less, more preferably an integer of 45 or less, still more preferably an integer of 30 or less. This structure can increase the productivity.

N is preferably an integer of 4 or greater and 90 or less, more preferably an integer of 8 or greater and 45 or less, still more preferably an integer of 12 or greater and 30 or less. This structure enables a higher diffraction efficiency and further reduction or prevention of haze while increasing the productivity.

As shown in FIG. 1, the first alignment treatment region 200R₁ to the N-th alignment treatment region 200R_{N} are preferably arranged concentrically in order from the central portion to the end portion of the alignment film 200.

As shown in FIG. 2, the alignment film 200 has the protruded and recessed shape 200U on its surface on the optically anisotropic layer 300 side. The protruded and recessed shape 200U is composed of the multiple i-th protrusions 200Aᵢ (i represents an integer of 1 to N). In other words, the protruded and recessed shape 200U is composed of the multiple first protrusions 200A₁ to the multiple N-th protrusions 200A_{N}. The first protrusions 200A₁ to the N-th protrusions 200A_{N} are referred to also as simply protrusions 200A.

The first direction 200D₁ to the (N−1)th direction 200D_{N-1} are not parallel to one another, and the N-th direction 200D_{N} is parallel to the first direction 200D₁. Also herein, two straight lines (including axes, directions, and azimuths) being parallel to each other means that the angle (absolute value) between them falls within a range of 0°±3°, preferably within a range of 0°±1°, more preferably within a range of 0°±0.5°, particularly preferably 0° (perfectly parallel).

With a direction identical to the first direction 200D₁ taken as a reference direction in a plan view, the angle between the N-th direction 200D_{N} and the reference direction is within a range of 180°±3°, the angles between each of the second direction 200D₂ to the (N−1)th direction 200D_{N-1} and the reference direction increase progressively in ascending order within a range of greater than the angle between the first direction 200D₁ and the reference direction and less than the angle between the N-th direction 200D_{N} and the reference direction. This structure enables a higher diffraction efficiency. The angle herein means the angle in a plan view of the optical element, and is measured positive in the clockwise direction from the reference direction (angle 0°) and measured negative in the counterclockwise direction from the reference direction (angle 0°). Both the counterclockwise and clockwise directions are rotational directions when the optical element is viewed from the observation surface side (front).

With a direction identical to the first direction 200D₁ taken as a reference direction in a plan view, the optical element 10 preferably satisfies the following Inequality (A). This structure more effectively enables a high diffraction efficiency.

$$\{ \frac{( i - 1 ) \times 180 °}{( N - 1 )} \} - 3 ° < Angle between i - th direction and reference direction < \{ \frac{( i - 1 ) \times 180 °}{( N - 1 )} \} + 3 ° \qquad Inequality ( A )$$

In Inequality (A), i represents an integer of 2 or greater and N or less.

As described above, the first direction 200D₁ to the N-th direction 200D_{N} are set such that the directions discretely make a 180° rotation in the plane. In other words, the longitudinal directions of the protrusions 200A of the protruded and recessed shape 200U are set such that they discretely make a 180° rotation in the plane.

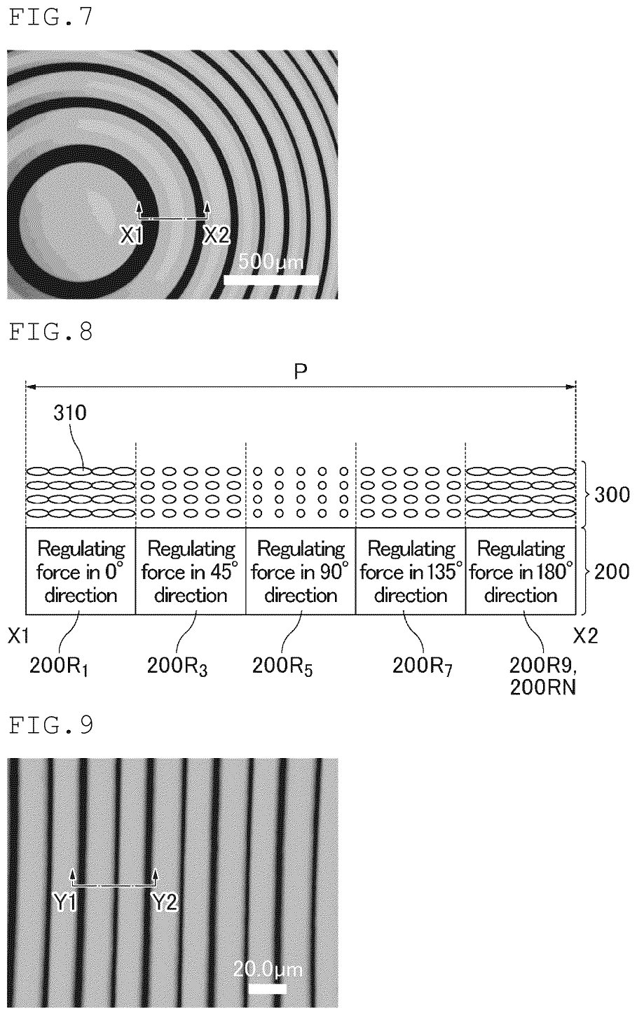

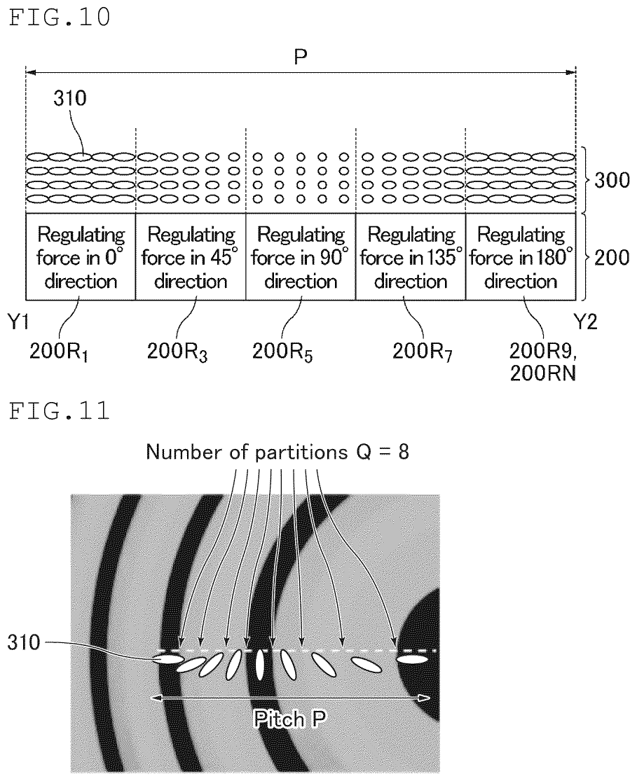

FIG. 7 is a polarizing microscope photograph showing an example optical element of Embodiment 1. FIG. 8 is a schematic cross-sectional view of the optical element of Embodiment 1 taken along line X1-X2 in FIG. 7. FIG. 9 is a polarizing microscope photograph showing an example optical element of Embodiment 1. FIG. 10 is a schematic cross-sectional view of the optical element of Embodiment 1 taken along line Y1-Y2 in FIG. 9. FIG. 11 is a polarizing microscope photograph showing an example optical element of Embodiment 1.

The alignment film 200 of the optical element 10 shown in FIG. 7 to FIG. 10 includes the first alignment treatment region 200R₁ to the N-th alignment treatment region 200R_{N} (specifically, N=9). In FIG. 8 and FIG. 10, the second, fourth, sixth, and eighth alignment treatment regions are omitted. The optical element 10 shown in FIG. 7 to FIG. 10 actually includes the second alignment treatment region between the first alignment treatment region 200R₁ and the third alignment treatment region 200R₃, the fourth alignment treatment region between the third alignment treatment region 200R₃ and the fifth alignment treatment region 200R₅, the sixth alignment treatment region between the fifth alignment treatment region 200R₅ and the seventh alignment treatment region 200R₇, and the eighth alignment treatment region between the seventh alignment treatment region 200R₇ and the ninth alignment treatment region 200R₉. FIG. 7 and FIG. 8 show the case where the pitch P is 500 μm. FIG. 9 and FIG. 10 show the case where the pitch P is 40 μm. The pitch P means the total length of the first alignment treatment region 200R₁ to the N-th alignment treatment region 200R_{N} on a straight line from the central portion toward the end portion of the alignment film 200. In other words, the pitch P means the interval at which the alignment direction of the anisotropic molecules 310 changes by 180°. Specifically, the pitch P means the spatial period of rotation of the molecular axes of RMs in the plane.

In the case of a pitch P of 500 μm, as shown in FIG. 7 and FIG. 8, the regulating forces of the alignment film 200 with the protruded and recessed shape 200U are discrete and the molecular alignments of the anisotropic molecules 310 are also discrete. Meanwhile, in the case of a pitch P of 40 μm, as shown in FIG. 9 and FIG. 10, the regulating forces of the alignment film 200 with the protruded and recessed shape 200U are discrete but the molecular alignments of the anisotropic molecules 310 are continuous, which can further increase the diffraction efficiency. Even in such a case where the protruded and recessed shape 200U has a discrete alignment regulating force distribution, RMs may be aligned continuously by making the number of partitions Q equal to or greater than a certain number. This enables continuous, almost ideal molecular alignments which cannot be achieved by the common mask exposure or the like process, thus further increasing the diffraction efficiency.

The number of partitions Q is, as shown in FIG. 11, the number of boundaries between the alignment treatment regions of the alignment film 200 within the pitch P. This means that the number of partitions Q equals N−1. In other words, the number of partitions Q means the number of types of alignment regulating force directions when the protruded and recessed shape 200U of the alignment film 200 makes a 180° discrete rotation in the plane. For example, as shown in FIG. 7 to FIG. 10, in the alignment film 200 including the first alignment treatment region to the ninth alignment treatment region, the number of boundaries between the alignment treatment regions within the region in which the alignment direction of the anisotropic molecules 310 changes by 180° is 8, so that the number of partitions Q is 8.

The optical element 10 preferably satisfies the following Inequality (B1), more preferably the following Inequality (B2). This structure can align the anisotropic molecules 310 in the optically anisotropic layer 300 continuously, thus effectively increasing the diffraction efficiency.

$$\frac{( Pitch P )}{( Number of partitions Q )} < 22.5 μm \qquad Inequality ( B1 )$$

$$\frac{( Pitch P )}{( Number of partitions Q )} \leq 10 μm \qquad Inequality ( B2 )$$

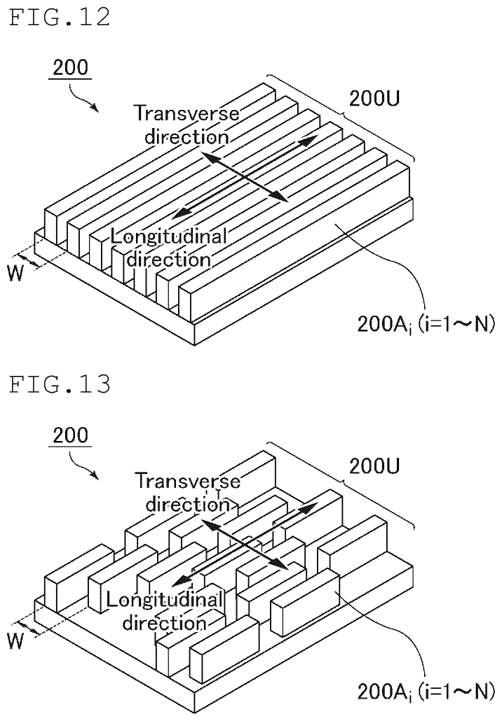

FIG. 12 and FIG. 13 are each a schematic perspective view showing an example protruded and recessed shape of the alignment film in the optical element of Embodiment 1. As shown in FIG. 12 and FIG. 13, the i-th protrusions 200Aᵢ are each an elongated wall-shaped portion, and the longitudinal directions of the i-th protrusions 200Aᵢ are set along the same direction (i-th direction 200Dᵢ). This structure enables the protruded and recessed shape 200U on the surface of the alignment film 200 on the optically anisotropic layer 300 side. The longitudinal directions of the protrusions 200A constituting the protruded and recessed shape 200U (i.e., the longitudinal directions of the wall-shaped portions) correspond to the alignment regulating force directions.

The protruded and recessed shape 200U shown in FIG. 12 has a wire grid-like elongated protruded and recessed structure. The protruded and recessed shape 200U shown in FIG. 12 is obtainable by, for example, arranging wire grid-like grooves having a length of several micrometers to several centimeters in the identical directions.

The protruded and recessed shape 200U shown in FIG. 13 has a protruded and recessed structure achieved by aligning nanorods. The protruded and recessed shape 200U shown in FIG. 13 is obtainable by, for example, arranging nanoscale grooves.

The height H of the first protrusions 200A₁ to the N-th protrusions 200A_{N} is preferably less than the phase difference (Δn×d) of the optically anisotropic layer 300. This structure enables a higher diffraction efficiency and further reduction or prevention of haze. Here, Δn and d respectively represent the birefringent index and the thickness of the optically anisotropic layer 300. The height H of the first protrusions 200A₁ to the N-th protrusions 200A_{N} means the average height of the first protrusions 200A₁ to the N-th protrusions 200A_{N}. The height H of the first protrusions 200A₁ to the N-th protrusions 200A_{N} can be measured with, for example, a non-contact surface roughness measurement device in conformity with ISO 25178.

The protrusion pitch W, which is the pitch of the first protrusions 200A₁ to the N-th protrusions 200A_{N}, preferably satisfies the following Inequality (C). This structure enables a higher diffraction efficiency and further reduction or prevention of haze.

$$Protrusion pitch W < \frac{( Pitch P )}{( Number of partitions Q )} \qquad Inequality ( C )$$

As shown in FIG. 12 and FIG. 13, the protrusion pitch W means, in a plan view, the distance between protrusions in a transverse direction orthogonal to the longitudinal directions of the protrusions, i.e., the distance from the end portion of a given protrusion on one side in the transverse direction to the end portion of a protrusion adjacent to the given protrusion on the one side in the transverse direction.

Suitable as the optically anisotropic layer 300 is, for example, a cured product of a polymerizable liquid crystal material (also referred to as “reactive mesogens”). In this case, a polymerizable liquid crystal material in at least one of a polymerized state or an unpolymerized state corresponds to the anisotropic molecules 310. The polymerizable liquid crystal material is preferably a photopolymerizable liquid crystal material that can be cured when irradiated with light.

The optically anisotropic layer 300 can be formed by, for example, applying a polymerizable liquid crystal material (reactive mesogens) and curing the material. The polymerizable liquid crystal material used is a liquid crystalline polymer having a photoreactive group. Examples of the polymerizable liquid crystal material include polymers each having a structure with both a substituent (mesogen group) and a photoreactive group in its side chain and having an acrylate, methacrylate, maleimide, N-phenylmaleimide, or siloxane, or another structure in its main chain. The mesogen group may be a biphenyl group, a terphenyl group, a naphthalene group, a phenylbenzoate group, an azobenzene group, or a derivative of any of these groups. The photoreactive group may be a cinnamoyl group, a chalcone group, a cinnamylidene group, a β-(2-phenyl)acryloyl group, a cinnamic acid group, or a derivative of any of these groups. The polymer may be a homopolymer consisting of a single repeat unit or may be a copolymer consisting of two or more repeat units different in side chain structure. The copolymer encompasses all of alternating copolymers, random copolymers, and graft copolymers. In the copolymer above, a side chain of at least one repeat unit has a structure including both the mesogen group and the photoreactive group, and a side chain of any other repeat unit may not have the mesogen group or the photoreactive group.

The polymerizable liquid crystal material may contain additives such as a photopolymerization initiator. Non-limiting examples of the photopolymerization initiator include conventionally known ones.

Examples of the solvent used for the polymerizable liquid crystal material include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxy butyl acetate, N-methyl pyrrolidone, and dimethylacetamide. Any of these may be used alone or two or more of these may be used in combination.

As shown in FIG. 1, the optically anisotropic layer 300 preferably has, in regions of the optically anisotropic layer corresponding to the first alignment treatment region 200R₁ to the N-th alignment treatment region 200R_{N}, molecular alignments along the first direction 200D₁ to the N-th direction 200D_{N}, respectively. This structure can align the anisotropic molecules 310 in a more continuous, periodic pattern in the plane, thus achieving a higher diffraction efficiency. The molecular alignment means the alignment film side molecular alignment in the optically anisotropic layer.

As shown in FIG. 1, preferably, the anisotropic molecules 310 are molecules having an elongated shape, and in regions of the optically anisotropic layer corresponding to the first alignment treatment region 200R₁ to the N-th alignment treatment region 200R_{N}, respectively, the anisotropic molecules 310 are aligned with their long axes lying along the first direction 200D₁ to the N-th direction 200D_{N}. This structure can align the anisotropic molecules 310 in a more continuous, periodic pattern in the plane, thus achieving a higher diffraction efficiency.

Next, the method for producing the optical element 10 of the present embodiment is described.

The method for producing the optical element 10 of the present embodiment includes, as shown in FIG. 4, transferring including transferring the protruded and recessed structure of the die 400 onto the resin layer to form the alignment film 200; and forming a liquid crystal layer including placing a polymerizable liquid crystal material on a surface of the alignment film 200 onto which the shape of the die 400 has been transferred, followed by curing the material. The die 400 includes, as shown in FIG. 5, a first region 400R₁ to an N-th region 400R_{N} arranged in order from a portion corresponding to the central portion of the alignment film 200 to a portion corresponding to the end portion of the alignment film 200. The first region 400R₁ to the N-th region 400R_{N} respectively include first wall-shaped portions 400A₁ to N-th wall-shaped portions 400A_{N} respectively extending in the first direction 200D₁ to the N-th direction 200D_{N}. The first direction 200D₁ to the (N−1)th direction 200D_{N-1} are not parallel to one another. The N-th direction 200D_{N} is parallel to the first direction 200D₁. N is an integer of 3 or greater. The portion corresponding to the central portion of the alignment film 200 may not necessarily be the central portion of the die 400. Also, the portion corresponding to the end portion of the alignment film 200 may not necessarily be the end portion of the die 400.

The first region 400R₁ to the N-th region 400R_{N} of the die 400 respectively correspond to the first alignment treatment region 200R₁ to the N-th alignment treatment region 200R_{N} of the alignment film 200. In other words, the protruded and recessed structures of the first region 400R₁ to the N-th region 400R_{N} of the die 400 are respectively transferred onto the first alignment treatment region 200R₁ to the N-th alignment treatment region 200R_{N} of the alignment film 200. For example, the protruded and recessed structure of the first region 400R₁ of the die 400 is transferred onto the first alignment treatment region 200R₁ of the alignment film 200.

The method for producing the optical element 10 of the present embodiment may include, before the transferring, forming a resin layer including applying an alignment film material containing an alignment film polymer to the supporting substrate 100 to form a resin layer. In the forming of a rein layer, a coater such as a slit coater or a spin coater can be suitable for application of the alignment film material. The alignment film material, after being applied to a uniform thickness, for example, may be pre-baked at a temperature of about 70° C. to 100° C. for 1 to 10 minutes.

The forming of a liquid crystal layer is a process of placing a polymerizable liquid crystal material on the surface of the alignment film 200 onto which the shape of the die 400 has been transferred, followed by curing the material. In the forming of a liquid crystal layer, the polymerizable liquid crystal material is placed on the alignment film 200 by coating, for example. A coater such as a slit coater or a spin coater is suitable for the coating. The polymerizable liquid crystal material is cured using, for example, an exposure device that emits light (ultraviolet rays) having a wavelength of from 313 to 365 nm.

### EXAMPLES

The present invention is described in more detail below with reference to examples, comparative examples, and a reference example.

### Comparative Example 1 and Comparative Example 2

An optical element of Comparative Example 1 was produced as follows. First, a photoalignment film was applied to a glass substrate, and the photoalignment film was irradiated with polarized ultraviolet (polarized UV) rays with a dose of 75 mJ/cm². After the polarized UV irradiation, the workpiece was left at 160° C. for 20 minutes, and RMs were applied to the photoalignment film at 1000 rpm. After the RM application, the workpiece was left at 60° C. for 60 seconds, and then irradiated with unpolarized UV rays with a dose of 200 mJ/cm² to obtain the optical element of Comparative Example 1.

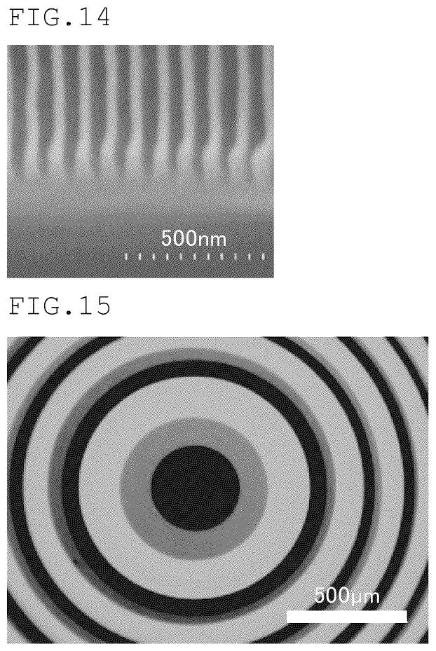

FIG. 14 is a scanning electron microscope photograph of a die used in production of an optical element of Comparative Example 2. The optical element of Comparative Example 2 was produced as follows. First, the die (wire grid) having the protruded and recessed structure shown in FIG. 14 was transferred onto the resin layer provided on the glass substrate to form the alignment film. RMs were applied at 1000 rpm to the surface of the alignment film onto which the protruded and recessed structure has been transferred. After the RM application, the workpiece was left at 60° C. for 60 seconds, and then irradiated with unpolarized UV rays with a dose of 200 mJ/cm² to obtain the optical element of Comparative Example 2.

The optical elements of Comparative Example 1 and Comparative Example 2 were subjected to evaluations of the phase difference (Δnd) and haze. The phase difference was measured with AxoScan available from Opto Science, Inc. The haze was measured with NDH 2000 available from Nippon Denshoku Industries Co., Ltd. The following Table 1 shows the results. For PBOE production, preferably, the phase difference provided to light with a wavelength of 550 nm is 260 nm or more and the haze is 0.20 or lower.

TABLE 1

| | Comparative Example 1 | Comparative Example 2 |
|---|---|---|
| | RM application to | RM application to |
| | photoalignment film | protrusions and recesses |
| Δnd (@550 nm) | 267 nm | 286 nm |
| Haze | 0.20 | 0.16 |

Table 1 shows that in Comparative Example 1 and Comparative Example 2, the phase difference and the haze were both sufficient for PBOE production. The optical elements of Comparative Example 1 and Comparative Example 2 were both usable for PB lens production as they both functioned as half-wave plates. The alignment film with the protruded and recessed shape used in Comparative Example 2 was also found to have an alignment regulating force similar to that of a photoalignment film. The diffraction efficiency was not measurable for the optical elements of Comparative Example 1 and Comparative Example 2 because they did not cause diffraction as a result of patterning in a uniform direction.

### Example 1

An optical element of Example 1 corresponding to the optical element of Embodiment 1 was produced. First, an alignment film material containing an alignment film polymer was applied to a glass substrate to form a resin layer. A die was provided in advance with a protruded and recessed structure produced using aluminum wires. The protruded and recessed structure was transferred onto the resin layer to obtain an alignment film. The protruded and recessed structure was patterned as shown in FIG. 5 and FIG. 6 to allow production of the optical element (PBOE) of Embodiment 1. In the present example, a PBOE with its alignment regulating force partitioned into 8 was produced. Specifically, the first direction was set at 0°, the second direction at 22.5°, the third direction at 45°, the fourth direction at 67.5°, the fifth direction at 90°, the sixth direction at 112.5°, the seventh direction at 135°, the eighth direction at 157.5°, and the ninth direction at 180° (in other words, parallel to the first direction).

Next, RMs were applied by a spin coater to the surface of the alignment film onto which the protruded and recessed structure had been transferred. The thickness of the film of the RMs was set such that the phase difference provided to light with a wavelength of 532 nm would be λ/2. The RMs after being applied were cured with UV to obtain the optical element of Example 1. FIG. 15 shows the results of observing the optical element of Example 1 using a polarizing microscope. FIG. 15 is a polarizing microscope photograph of the optical element of Example 1.

Since the optical element of Example 1 has been produced without mask exposure, the decrease in diffraction efficiency due to a decrease in alignment accuracy is avoided, so that a high diffraction efficiency (for example, diffraction efficiency of 90% or higher) can be achieved. Also, the same region of the alignment film is not irradiated with mutually orthogonal polarized ultraviolet rays, so that a low haze (for example, a haze of 0.30 or lower) can be achieved.

The alignment directions of the molecules in the optically anisotropic layer in the optical element of Example 1 were evaluated as follows. The PBOE (optical element) was observed with a polarizing microscope to measure changes in luminance within the pitch (180° molecular rotation). The molecular alignments were evaluated as being discrete when the changes exhibited a plateau. The molecular alignments were evaluated as being continuous (continuous alignment) when the changes in luminance were continuous.

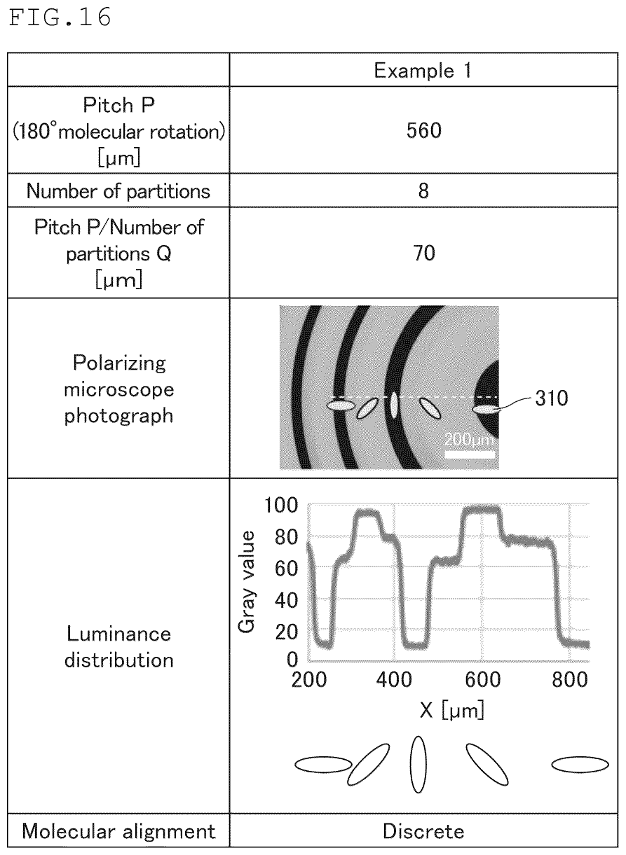

The evaluation results of the optical element of Example 1 are shown in FIG. 16. FIG. 16 is a diagram showing the evaluation results of the optical element of Example 1. As shown in FIG. 16, the pitch (180° molecular rotation) of the optical element of Example 1 was 560 μm. The alignment regulating force was partitioned into 8 (first direction at 0°, the second direction at 22.5°, the third direction at 45°, the fourth direction at 67.5°, the fifth direction at 90°, the sixth direction at 112.5°, the seventh direction at 135°, the eighth direction at 157.5°).

The polarizing microscope photograph in FIG. 16 shows the alignment directions of the anisotropic molecules 310. The one dimensional luminance distribution indicated by the dashed lines on the polarizing microscope photograph was made into a graph by image processing. The graph showed a luminance plateau. This suggests that the anisotropic molecules 310 (RMs) are aligned according to the alignment regulating forces of the base, so that the RMs are aligned discretely.

### Example 2 to Example 4

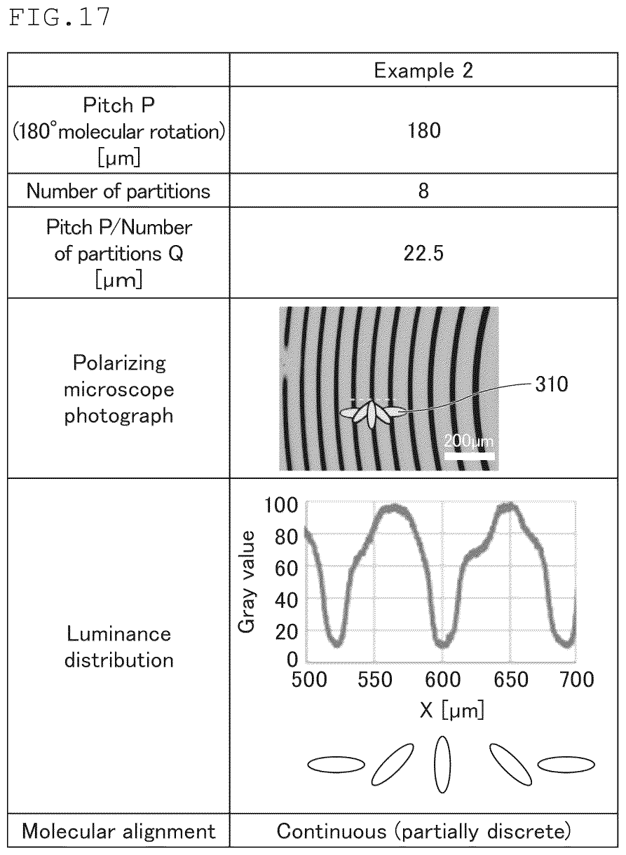

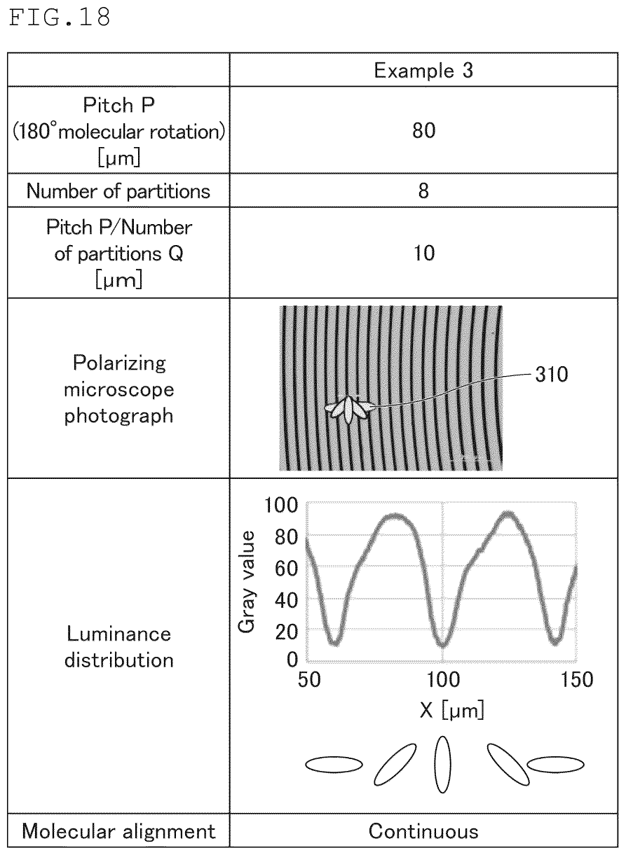

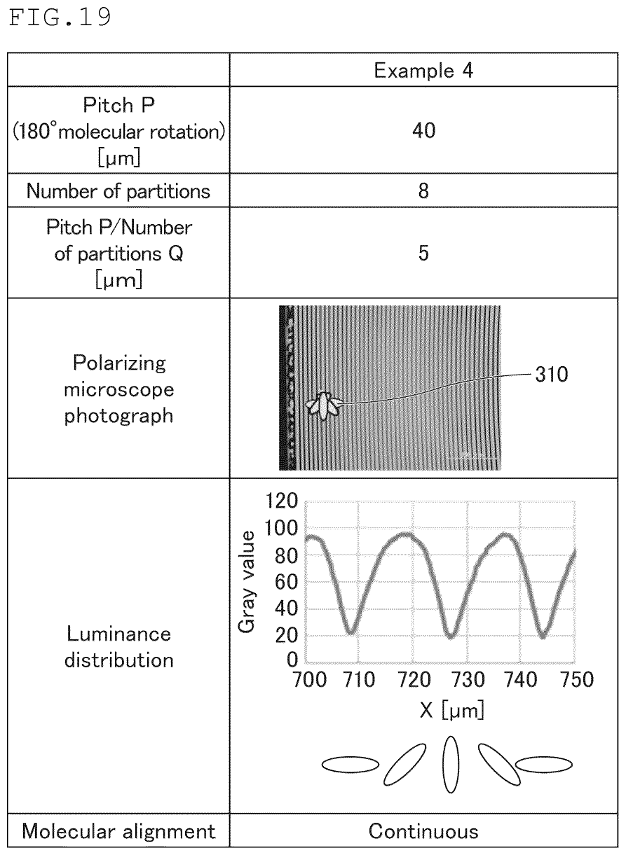

The pitch P (180° molecular rotation) of the optical element (PBOE) of Example 1 was designed to be smaller at a position farther from the center of the optical element in a plan view. Thus, the optical element of Example 1 was used to examine the molecular alignments in the regions with different pitches P. In Example 2 to Example 4, the molecular alignment was determined in the region with a pitch P of 180 μm, the region with a pitch P of 80 μm, and the region with a pitch P of 40 μm, respectively. The results are shown in FIG. 17 to FIG. 19. FIG. 17 is a diagram showing the evaluation results of an optical element of Example 2. FIG. 18 is a diagram showing the evaluation results of an optical element of Example 3. FIG. 19 is a diagram showing the evaluation results of an optical element of Example 4.

As shown in FIG. 17 to FIG. 19, the numbers of partitions Q relative to the pitch P ((pitch P)/(the number of partitions Q)) in Example 2 to Example 4 were respectively 22.5 μm, 10 μm, and 5 μm, and were smaller than 70 μm in Example 1. When the ratio (pitch P)/(the number of partitions Q) was 22.5 μm, the molecular alignments were almost continuous, but were partially discrete. When the ratio (pitch P)/(the number of partitions Q) was 10 μm and when it was 5 μm, the molecular alignments were completely continuous. These results show that when the ratio of (pitch P)/(the number of partitions Q) was smaller than 22.5 μm, the RMs were aligned continuously even though the base (alignment film 200) had discrete alignment regulating forces. The results therefore suggest that a higher diffraction efficiency can be achieved when the ratio (pitch P)/(the number of partitions Q) is smaller than 22.5 μm.

The ratio (pitch P)/(the number of partitions Q) is a parameter introduced to generalize the present consideration. The same consideration is applicable even when the pitch P or the number of partitions Q changes.

### Diffraction Efficiency (Calculated) of Optical Element of Reference Example 1

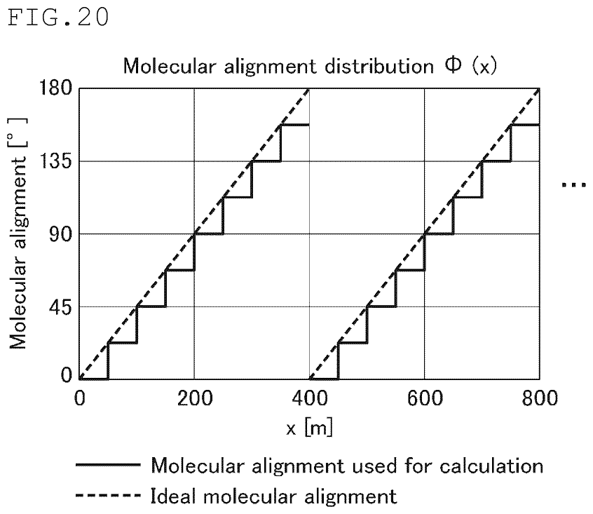

The diffraction efficiency of the optical element of Reference Example 1 was determined by simulation. FIG. 20 is a diagram showing the molecular alignments used for calculation of the diffraction efficiency of an optical element of Reference Example 1. The optical element of Reference Example 1 has 8 types of molecular alignments and can be modeled as shown in FIG. 20. Thus, based on the molecular alignments shown in FIG. 20, the diffraction efficiency of the optical element of Reference Example 1 was determined by simulation. The optical element of Reference Example 1 was, as shown in FIG. 20, a one-dimensional diffraction grating having 8 types of molecular alignments of 0°, 22.5°, 45°, 67.5°, 90°, 112.5°, 135°, and 157.5°.

The diffraction efficiency of the optical element (PBOE) can be calculated using the Fraunhofer diffraction once the molecular alignments are determined. The calculation formula for diffraction efficiency n is given by the following Equation (D1). In the following Equation (D1), A represents a period on the x-axis and Φ(x) represents a molecular alignment in FIG. 20. Here, the PBOE, which is an optical element, has a molecular alignment that is periodical in the x-axis direction. This period is taken as Λ[m]. Affecting the angle of diffraction but not affecting the diffraction efficiency, Λ was set to an appropriate value in the present calculation.

$$η = {\vert \frac{1}{Λ} {\int }_{0}^{Λ} exp \{ \frac{i πΦ ( x )}{90} \} exp ( - i \frac{2 π x}{Λ} ) dx \vert}^{2} \qquad Equation ( D1 )$$

The diffraction efficiency (calculated) of the optical element of Reference Example 1 calculated from the above Equation (D1) was 95%.

### Diffraction Efficiency (Measured) of Optical Element of Example 4

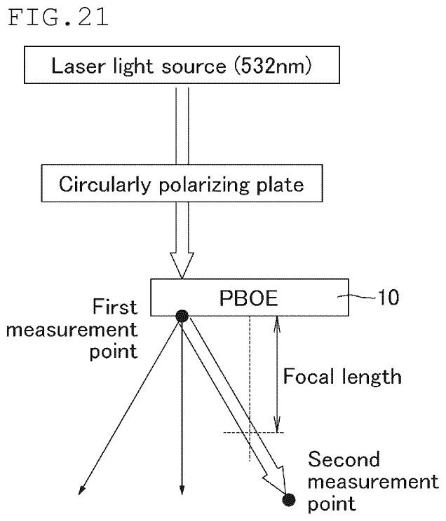

FIG. 21 is a schematic view showing a method for measuring diffraction efficiency. The diffraction efficiency of the optical element of Example 4 was measured. The diffraction efficiency was measured using the system shown in FIG. 21 and the laser light source was one with a wavelength of 532 nm. In measuring the diffraction efficiency, light emitted from the laser light source first passes through a circularly polarizing plate to be emitted as circularly polarized light toward the optical element 10. The principal light transmitted through the outer periphery of the optical element 10 travels toward the focal point. On the other hand, unnecessary light such as the zeroth order light is diffracted in a direction different from that of the principal light. The diffraction efficiency is defined by the following Equation (D2).

$$Diffraction efficiency = ( Principal light intensity ) \div ( Total transmission light intensity ) \times 100 \qquad Equation ( D2 )$$

Thus, the light intensity was measured at the first measurement point and the second measurement point shown in FIG. 21. The light intensity measured at the first measurement point was taken as the total transmission light intensity. The light intensity measured at the second measurement point was taken as the principal light intensity. The diffraction efficiency was calculated from these measured values using Equation (D2). As a result of the calculation, the diffraction efficiency (measured) of the optical element of Example 4 was 98%. The calculated diffraction efficiency of the optical element of Reference Example 1 and the measured diffraction efficiency of the optical element of Example 4 are shown in the following Table 2.

TABLE 2

| | Reference Example 1 | Example 4 |
|---|---|---|
| | Calculated value | Measured value |
| Diffraction | 95% | 98% |
| efficiency | | |

A diffraction efficiency closer to 100% is more preferred. The results in Table 2 demonstrate that the optical element of Example 4 achieved a higher diffraction efficiency than the calculated diffraction efficiency. This is presumably because the optically anisotropic layer 300 had continuous molecular alignments in Example 2 to Example 4 as shown in FIG. 17 to FIG. 19 even though the alignment film 200 exerted discrete alignment regulating forces. The calculated diffraction efficiency here was determined assuming that the molecular alignments of the optically anisotropic layer 300 were discrete.

### REFERENCE SIGNS LIST

10: optical element
100: supporting substrate
200: alignment film
200A, 200Aᵢ (i=integer of 1 or greater and N or less): protrusion
200Dᵢ (i=integer of 1 or greater and N or less): direction
200Rᵢ (i=integer of 1 or greater and N or less): alignment treatment region
200U: protruded and recessed shape
300: optically anisotropic layer
310: anisotropic molecules
400: die
400Aᵢ (i=integer of 1 or greater and N or less): wall-shaped portion
400Rᵢ (i=integer of 1 or greater and N or less): region
H: height
P: pitch
Q: number of partitions
W: protrusion pitch

What is claimed is:

1. An optical element comprising:
an alignment film; and
an optically anisotropic layer provided on the alignment film and containing anisotropic molecules,
the alignment film including a first alignment treatment region to an N-th alignment treatment region arranged in order from a central portion to an end portion of the alignment film in a plan view,
the first alignment treatment region to the N-th alignment treatment region respectively including first protrusions to N-th protrusions which protrude toward the optically anisotropic layer and respectively extend in a first direction to an N-th direction,
the first direction to an (N−1)th direction being not parallel to one another,
the N-th direction being parallel to the first direction,
N being an integer of 3 or greater.

2. The optical element according to claim 1,
wherein with a direction identical to the first direction taken as a reference direction in a plan view,
an angle between the N-th direction and the reference direction is within a range of 180°±3°, and
angles between each of the second direction to the (N−1)th direction and the reference direction increase progressively in ascending order within a range of greater than an angle between the first direction and the reference direction and less than the angle between the N-th direction and the reference direction.

3. The optical element according to claim 1,
wherein with a direction identical to the first direction taken as a reference direction in a plan view, an angle between an i-th direction and the reference direction satisfies the following Inequality (A):
$$\{ \frac{( i - 1 ) \times 180 °}{( N - 1 )} \} - 3 ° < Angle between i - th direction and reference direction < \{ \frac{( i - 1 ) \times 180 °}{( N - 1 )} \} + 3 ° \qquad Inequality ( A )$$
where i represents an integer of 2 or greater and N or less.

4. The optical element according to claim 1,
wherein the following Inequality (B1) holds:
$$\frac{( Pitch P )}{( Number of partitions Q )} < 22.5 μm \qquad Inequality ( B1 )$$
where the pitch P is a total length of the first alignment treatment region to the N-th alignment treatment region on a straight line from the central portion to the end portion of the alignment film, and the number of partitions Q equals N−1.

5. The optical element according to claim 1,
wherein the following Inequality (B2) holds:
$$\frac{( Pitch P )}{( Number of partitions Q )} \leq 10 μm \qquad Inequality ( B2 )$$
where the pitch P is a total length of the first alignment treatment region to the N-th alignment treatment region on a straight line from the central portion to the end portion of the alignment film, and the number of partitions Q equals N−1.

6. The optical element according to claim 1,
wherein a height H of the first protrusions to the N-th protrusions is less than a phase difference Δnd of the optically anisotropic layer.

7. The optical element according to claim 1,
wherein a protrusion pitch W satisfies the following Inequality (C):
$$Protrusion pitch W < \frac{( Pitch P )}{( Number of partitions Q )} \qquad Inequality ( C )$$
where the protrusion pitch W is a pitch of the first protrusions to the N-th protrusions, the pitch P is a total length of the first alignment treatment region to the N-th alignment treatment region on a straight line from the central portion to the end portion of the alignment film, and the number of partitions Q equals N−1.

8. The optical element according to claim 1,
wherein the anisotropic molecules are molecules having an elongated shape, and
in regions of the optically anisotropic layer corresponding to the first alignment treatment region to the N-th alignment treatment region, respectively, the anisotropic molecules are aligned with their long axes lying along the first direction to the N-th direction.

9. The optical element according to claim 1,
wherein N is 4 or greater.

10. A method for producing an optical element, the method comprising:
transferring including transferring a protruded and recessed structure of a die onto a resin layer to form an alignment film; and
forming a liquid crystal layer including placing a polymerizable liquid crystal material on a surface of the alignment film onto which a shape of the die has been transferred, followed by curing the material,
the die including a first region to an N-th region arranged in order from a portion corresponding to a central portion of the alignment film to a portion corresponding to an end portion of the alignment film,
the first region to the N-th region respectively including first wall-shaped portions to N-th wall-shaped portions respectively extending in a first direction to an N-th direction,
the first direction to an (N−1)th direction being not parallel to one another,
the N-th direction being parallel to the first direction,
N being an integer of 3 or greater.
